(19) United States
(12) Patent Application Publication
(10) Pub. No.: US 2005/0206062 A1
(43) Pub. Date: Sep. 22, 2005

(54) Gatherer stitcher having a stitching station

(76) Inventors: Ralph Kuechler, Ehingen (DE); Thomas Gerlach, Tuttlingen (DE); Claus-Otto Hohner, Tuttlingen (DE)

Correspondence Address: William D. Breneman, Esq.;BRENEMAN & GEORGES, 3150 Commonwealth Avenue, Alexandria, VA, 22305, US

(21) Appl. No.: 11/076,283

(22) Filed: Mar. 10, 2005

(30) Foreign Application Priority Data
Mar. 10, 2004 (DE) 10 2004 011 973.2

(51) Int. Cl. B42B 2/00

(52) U.S. Cl. 270/52.18

(57) ABSTRACT

The invention proposes a gatherer stitcher having at least one stitching station (1) for stitching sheets, the stitching station being arranged on a stitching carriage that can move in the longitudinal direction (X) of a gatherer chain during the stitching operation and at least one ejector unit being provided after the stitching station in the transport direction of the sheets in order to eject the sheets, said gatherer stitcher exhibiting a higher operational reliability as compared with the prior art. According to the invention, this is achieved in that at least one acceleration and/or braking unit (4) for accelerating and/or braking the sheets in the longitudinal direction (X) toward the ejector unit is arranged between the stitching carriage and the ejector unit.

The invention relates to a gatherer stitcher having at least one stitching station for stitching sheets, according to the preamble of claim 1.

### PRIOR ART

Gatherer stitchers are generally paper-processing machines with which a product, for example a brochure, is assembled from a plurality of folded sheets and is stitched. Printed folded sheets from stacks, lying on folded sheet feeders or standing on the spine, are supplied in separated form, opened and placed on a gatherer chain. The number of folded sheets to be stitched is gathered and aligned on the gatherer chain by means of drivers. The gatherer chain transports the gathered folded sheets to a stitching device, where these are stitched with wire staples by means of stitching heads. Optionally, perforation of the products may be provided. In order to trim the edge of the stitched products, what is known as a trimmer (3-cutter) is normally provided after the ejector, from which the end products are transported onward to a delivery.

In gatherer stitchers, two stitching principles can expediently be employed: stitching at a standstill or stitching on the moving product. In order to perform stitching on the moving product, the stitching device, comprising stitching carriage and bending-over device or stitching station, has to be moved together with the product to be stitched and has to be coordinated with the movement of the latter, at least for some time.

The gatherer stitcher is often driven by a central electric motor. In this case, the various subassemblies, such as the stitching apparatus, the gatherer chain, the folded sheet feeder, the ejector, the trimmer and possibly further components are driven by various gear mechanisms and a common shaft, what is known as a king shaft.

The gatherer chain has a comparatively high transport speed, so that up to several booklets are produced per second. Because of this high transport speed of the sheets or booklets, it is possible for markings or scratching/rubbing tracks on the booklets and/or for tilting of the booklets to occur as a result of the deflection of the direction of movement of the booklets by means of the ejector. This leads, inter alia, to damage or impairment to the quality of the booklets produced.

It is precisely because of the aforementioned high transport speeds that even short stoppages of the gatherer stitcher lead to a considerable reduction in the booklets produced, on account of the faults described above. Furthermore, a relatively high overrun or backup with booklets wedged or jammed in one another is produced relatively quickly and in general can be eliminated only with a considerably great effort on repair.

### OBJECT AND ADVANTAGES OF THE INVENTION

It is an object of the invention to propose a gatherer stitcher having at least one stitching station for stitching sheets, the stitching station being arranged on a stitching carriage that can move in the longitudinal direction of a gatherer chain during the stitching operation and at least one ejector unit being provided after the stitching station in the transport direction of the sheets in order to eject the sheets, said gatherer stitcher exhibiting a higher operational reliability as compared with the prior art.

On the basis of a gatherer stitcher of the type mentioned at the beginning, this object is achieved by the characterizing features of claim 1.

Advantageous embodiments and developments of the invention are possible as a result of the measures cited in the subclaims.

Accordingly, a gatherer stitcher according to the invention is characterized by the fact that at least one acceleration and/or braking unit for accelerating and/or braking the sheets in the longitudinal direction toward the ejector unit is arranged between the stitching carriage and ejector unit. With the aid of this measure, it is possible in an elegant manner to implement an advantageous influence on or change in the transport speed of the sheets. In this way, the transport direction can advantageously be changed, in particular it can be decreased, in such a way that a deflection of the sheets, which follows or takes place thereafter in the transport direction, can be implemented with the aid of the ejector without impairing the sheets or the gatherer stitcher operation.

The accelerating and/or braking unit is advantageously designed first to accelerate and then subsequently to brake the sheets. As a result of the chronologically preceding acceleration of the sheets, it is possible to generate a gain in time with respect to the transport speed of the gatherer chain, so that braking the sheets, in particular down to a standstill, can be implemented without any overrun. This means that the average speed of the sheets in the region of the acceleration and/or braking unit is preferably not changed or reduced, or only comparatively little, as compared with the transport speed of the sheets on the gatherer chain.

Precisely by means of the advantageous braking at the end of this process step, it is ensured that disadvantageous markings or tracks/scratches on the sheets and/or tilting of the sheets as a result of the deflection of the transport direction of the sheets with the aid of the ejector are effectively prevented.

In an advantageous variant of the invention, the acceleration and/or braking unit comprises at least one carrier for driving the sheets. By means of the carrier, the gatherer chain in the region of the acceleration and braking unit can be dispensed with, which reduces the outlay on construction of the gatherer stitcher and also improves the handling of the gatherer chain.

The carrier preferably has at least one clamping unit for clamping the sheets. The fact that the clamping unit is arranged after the stitching station means that slipping of the individual sheets can no longer take place in this case. The clamping unit advantageously prevents any relative movement between sheet and clamping unit, so that markings on or impairments of the sheets do not arise.

In a particular development of the invention, the sheets can be clamped by at least two clamping finger elements and a clamping bar. Appropriate clamping fingers can be implemented particularly simply and, together with the clamping bar, ensure secure clamping and releasing of the clamping.

The acceleration and/or braking unit advantageously has a crank drive. With the aid of a crank drive according to the invention, the linear movement of the carrier or clamping unit can advantageously be produced by a rotational movement, in particular with the aid of an electric motor or the like.

In a preferred embodiment of the invention, the ejector device of the sheets in the region of the ejector unit is substantially perpendicular to the transport direction of the sheets in the region of the gatherer chain. In this way, in particular tilting of the booklets in the region of the ejector is effectively prevented, since the sheets are moved substantially at right angles to the fold and preferably along the transport direction of the ejector or along the units adjacent to the latter. This measure leads to a further increase in the operational reliability of the gatherer stitcher. Furthermore, transverse displacement or the like of the sheets or brochures with respect to corresponding machine parts is hereby prevented in an elegant manner, so that markings, such as tracks or scratches, are not produced on the sheets or brochures.

The ejector unit preferably has a lifting element for lifting the sheets and a belt apparatus for moving the sheets onward. A lifting element according to the invention engages in the fold of the sheets, for example, and lifts the latter substantially in the vertical direction away from a guide rail or the like or upward. In this case, the sheets are gripped by the advantageous belt apparatus and, in particular, supplied to the trimmer or the cutting unit.

In an advantageous variant of invention, the ejector unit lifts the braked sheets. In the chronological sequence of the gatherer stitcher according to the invention, the sheets are gathered, stitched, gripped by the acceleration and/or braking unit, these being braked in particular and then, in the braked state, in particular at a standstill, being gripped and lifted by the ejector unit and the lifting element. This advantageous chronological sequence increases the operational reliability of the gatherer stitcher according to the invention in a decisive manner, since appropriately braked or stopped sheets can be deflected and/or and lifted without disruption and supplied to the cutting unit. In general, it is advantageous to provide a deflection of the sheets, that is to say a considerable and relevant change in the transport direction of the sheets, in the braked state or with the sheets at a standstill.

### EXEMPLARY EMBODIMENT

An exemplary embodiment of the invention is illustrated in the drawing and will be explained in more detail in the following text by using figures, in which, in detail:

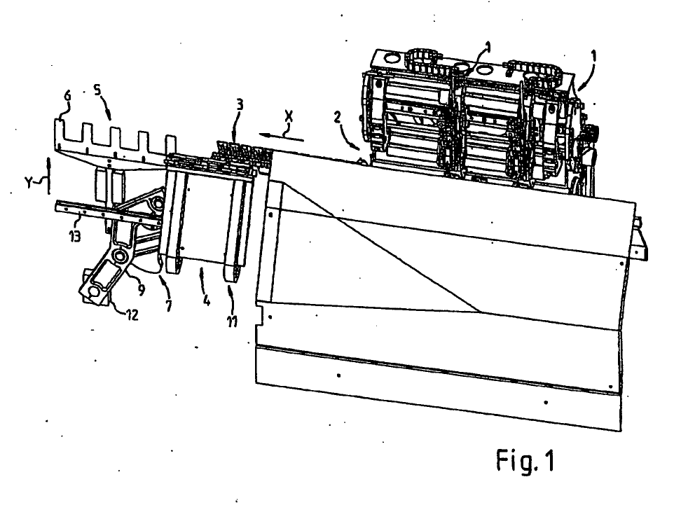

FIG. 1 shows a schematic, perspective illustration of a detail of a gatherer stitcher according to the invention and

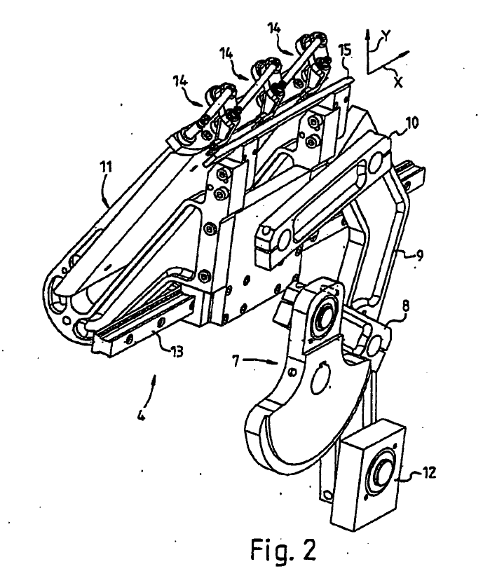

FIG. 2 shows a schematic, perspective illustration of an acceleration and/or braking unit according to the invention.

FIG. 1 illustrates a detail of a gatherer stitcher. The gatherer stitcher comprises two stitching stations 1, which are arranged such that they can be moved along a gatherer chain 3 on a stitching carriage 2 during the stitching operation.

Although not specifically illustrated, individual folded sheets are gathered before the stitching stations 1 in a known manner and are supplied to the latter 1 by means of a gatherer chain 3.

The gatherer chain 3 transfers the stitched sheets to a braking unit 4 and the latter in turn transfers the sheets to an ejector 5. The ejector 5 lifts the sheets substantially at right angles to the transport direction of the sheets of the gatherer chain 3 in the region of the braking unit 4. Here, according to the invention, a sheet is lifted by the ejector 5 or by the lifting comb 6 of the latter while at a standstill to the greatest possible extent and is supplied to a trimmer or a cutting unit, not specifically illustrated.

The braking unit 4 is illustrated in more detail in FIG. 2. The braking unit 4 is driven with the aid of a crank mechanism 7. The crank mechanism 7 drives a carriage 11 by means of a connecting rod 8, a swinging arm 9 and a pulling and pushing arm 10. In this case, the swinging arm 9 is mounted securely and in a fixed position by means of a bearing 12 with a fixed pivot.

The carriage 11 moves in the longitudinal direction of the gatherer chain 3 and along a rail 13 which, at the same time, guides the carriage 11 and forms the linear guide. In this variant of the invention, the carriage 11 has three clamping fingers 14 and a clamping bar 15, which grip and clamp the sheets, not specifically illustrated, in the direction X in the front region of the rail, then accelerate them longitudinally in the direction X and, in the rear region of the rail 13, brake the sheets, in particular down to a standstill. The sheets are then lifted in the direction Y by the comb 5 and supplied to a cutting apparatus.

The nub of the invention is the change in the direction of the sheets after the stitching carriage in a gatherer stitcher according to the preamble of claim 1 from the longitudinal direction X into the direction Y aligned substantially at right angles thereto with the aid of the braking unit 4, which brakes the sheets to a great extent or down to a standstill for the ejector 5. This ensures fault-free operation of the gatherer stitcher according to the invention. Furthermore, disadvantageous markings or tracks on the sheets to be processed are effectively prevented. This leads to an improvement in the quality of the sheets.

List of Designations:

1 Stitching station

2 Stitching carriage

3 Gatherer chain

4 Braking unit

5 Ejector

6 Comb

7 Crank mechanism

8 Connecting rod

9 Swinging arm

10 Pulling/pushing arm

11 Carriage

12 Bearing

13 Rail

14 Clamping finger

15 Clamping bar

x direction

y direction

1. A gatherer stitcher having at least one stitching station (1) for stitching sheets, the stitching station (1) being arranged on a stitching carriage (2) that can move in the longitudinal direction of a gatherer chain (3) during the stitching operation and at least one ejector unit (5) being provided after the stitching station (1) in the transport direction (X) of the sheets in order to eject the sheets, wherein at least one acceleration and/or braking unit (4) for accelerating and/or braking the sheets in the longitudinal direction (X) toward the ejector unit (5) is arranged between the stitching carriage (2) and the ejector unit (5).

2. The gatherer stitcher as claimed in claim 1, wherein the acceleration and/or braking unit (4) is designed for the prior acceleration and subsequent braking of the sheets.

3. The gatherer stitcher as claimed in one of the preceding claims, wherein the acceleration and/or braking unit (4) comprises at least one carrier (14, 15) for driving the sheets.

4. The gatherer stitcher as claimed in one of the preceding claims, wherein the carrier (14, 15) has at least one clamping unit (14, 15) for clamping the sheets.

5. The gatherer stitcher as claimed in one of the preceding claims, wherein the clamping unit (14, 15) comprises at least two clamping finger elements (14) and a clamping bar (15).

6. The gatherer stitcher as claimed in one of the preceding claims, wherein the acceleration and/or braking unit (4) has a crank drive (7).

7. The gatherer stitcher as claimed in one of the preceding claims, wherein the ejector direction (Y) of the sheets in the region of the ejector unit (5) is substantially perpendicular to the transport direction (X) of the sheets in the region of the gatherer chain (3).

8. The gatherer stitcher as claimed in one of the preceding claims, wherein the ejector unit (5) has a lifting element (6) for lifting the sheets and a belt apparatus for moving the sheets onward.

9. The gatherer stitcher as claimed in one of the preceding claims, wherein the ejector unit (5) lifts the braked sheets.
